(19) United States
(12) Patent Application Publication
(10) Pub. No.: US 2024/0379336 A1
(43) Pub. Date: Nov. 14, 2024

(54) SPECTRAL COMPARISON

(71) Applicant: DH Technologies Development Pte. Ltd., Singapore (SG)

(72) Inventors: Chang LIU, Richmond Hill (CA); Gordana IVOSEV, Etobicoke (CA); Hui ZHANG, Winchester, MA (US)

(21) Appl. No.: 18/691,598

(22) PCT Filed: Sep. 15, 2022
(86) PCT No.: PCT/IB2022/058735

§ 371 Date: Mar. 13, 2024

Related U.S. Application Data
(60) Provisional application No. 63/244,424, filed on Sep. 15, 2021.

(51) Int. Cl. H01J 49/00

(52) U.S. Cl. CPC H01J 49/0036

(57) ABSTRACT

Methods and systems for spectral comparison and quality assessment are disclosed. In one example, a method for assessing quality of a mass spectrum (MS) of a sample is provided. The method comprises: predefining one or more features or attributes indicative of the sample quality with reference to a target compound; and calculating a quality score for the MS with respect to the selected features or attributes.

### CROSS-REFERENCE TO RELATED APPLICATION

This application is being filed on Sep. 15, 2022, as a PCT International Patent Application that claims priority to and the benefit of U.S. Provisional Application No. 63/244,424, filed on Sep. 15, 2021, which application is hereby incorporated by reference in its entirety.

### INTRODUCTION

Chemical compound libraries are commonly used in the field of pharmaceutical discovery, combinatorial chemistry/reaction screening, clinical screening, inventory quality control, etc. It is important to assess and assure the quality and properties of a selected member chemical in a chemical compound library before using the member chemical. For example, in pharmaceutical discovery through the use of a biological reaction system, the assessment of the properties of drug candidates (e.g. inhibition effect of each drug structures on the protein function, the absorption, distribution, metabolism, and excretion properties, etc.) requires the dosing and incubation of each individual library member from a large (up to multimillion-sized) drug candidate library into the biological reaction system. The quality of the standard compound in the stock solution for each library member directly relates to the assay readout-the impurity and/or the degradation of the standard compound may cause the false positive/negative results. Therefore, it is desired to confirm the quality of each library member of the drug candidate library (compound quality control) before dosing to the assay reaction. However, there had been no suitable platform that could handle the compound quality control (QC) for the million-sized chemical library due to the throughput limitation and/or time inefficiency.

Conventionally, quality assessment of a sample through the use of mass spectrometry is based on limited attributes, e.g., the target ion intensity or the integrated m/z peak area as the only measurement, without comparing the mass spectrum of the sample with a reference spectrum or dataset. Absent spectral comparison, the conventional methods lack capability of describing the impurity profiles or interfering compounds, especially when the sample has a complex sample matrix or derives from a complex biological source or environment. The deficiency of limited or no spectral comparison may cause problems with identification of target compound, false positive or false negative results, overestimation or underestimation of sample potency, etc., especially in the context of compound QC for a large chemical library.

### SUMMARY

In one aspect, the present disclosure relates to a method for assessing quality of a mass spectrum (MS) of a sample. In one example, a method comprises: predefining one or more features or attributes indicative of the sample quality with reference to a target compound; and calculating a quality score for the MS with respect to the selected features or attributes.

In some embodiments, the predefined features are selected from the group of: expected m/z value for the target compound; intensity of the peak at expected m/z value for the target compound; fingerprint spectral feature of the target compound, spectral feature indicative of interference and/or amount of interference, spectral feature indicative of degradation or deterioration of the target compound, or combinations thereof.

In some embodiments, the method further comprises: extracting spectral features from the MS of the sample; comparing the extracted features to the predefined features indicative of sample quantity; optionally generating a comparison metric comprising the comparison between the extracted feature and the corresponding predefined feature; and calculating a combinatorial quality score indicative of at least one of the sample quality state.

In some embodiments, the method further comprises: identifying unexpected spectral features from the MS of the sample; and determining the existence or absence or quantity of an interfering compound based on the unexpected spectral features, wherein the interfering compound is selected from the group of: background noise, impurity, contaminant, a degradation product of the target compound, a deterioration product of the target compound, or any combination thereof.

In some embodiments, the sample is a sample of a member compound of a chemical or combinatorial library.

In some embodiments, the MS of the sample is used as a reference mass spectrum (RMS) with respect to the target compound, wherein the RMS has a determined spectral quality score. In some embodiments, the RMS of the sample is obtained at a first time. In some embodiments, the method further comprises: obtaining a test mass spectrum (TMS) of the sample at a second time; comparing the TMS with the RMS with respect to the predefined features indicative of the sample quality; calculating a spectral quality score for the TMS with reference to the target compound; and determining a quality state of the sample at the second time.

In some embodiments, the method further comprises: identifying a background or background signal(s) of the MS; and subtracting the background or background signal(s) from the MS. In some embodiments, the method further comprises calculating a quality score for the background-subtracted MS.

In some embodiments, the method further comprises: identifying a background or background signal(s) for each of RMS and/or the TMS; and subtracting the identified background or background signal(s) from the RMS and/or the TMS. In some embodiments, the method further comprises: comparing the background-subtracted RMS with the background-subtracted TMS to calculate the spectral quality score.

In some embodiments, the method further comprises: building a reference spectral library for a chemical library, wherein the chemical library comprises at least one member compound, and wherein the reference spectral library comprises RMS of selected or all member compound(s).

In some embodiments, the quality score of the MS is calculated using a heuristic method. In other embodiments, the quality score of the MS is calculated using a machine learning method.

In another aspect, the present disclosure relates to a method of assessing quality of a sample. In one example, the method comprises: comparing a test mass spectrum (TMS) of the sample with a corresponding reference mass spectrum (RMS) of the sample; comparing the spectral features extracted from the TMS with predefined features or attributes derived from the RMS, wherein the predefined features or attributes are indicative of sample quality with reference to a target compound of the sample; optionally generating a comparison metric comprising the comparisons between each extracted spectral feature and the corresponding pre-defined feature; calculating a combinatorial quality score based on the comparison, wherein the combinatorial score is indicative of at least one quality state of the sample. In some embodiments, the quality state of the sample is selected from the group of: impurity level, contaminant, degradation of the target compound, deterioration of the target compound.

In some embodiments, the method further comprises: identifying a background or background signal(s) for each of RMS and/or the TMS; and subtracting the identified background or background signal(s) from the RMS and/or the TMS. In some embodiments, the method further comprises: comparing the background-subtracted RMS with the background-subtracted TMS to calculate the spectral quality score.

In yet another aspect, the present disclosure relates to a method of determining a quality state of a sample. In one example, a method comprises: comparing spectral quality of a test mass spectrum (TMS) of the sample with spectral quality of a corresponding reference mass spectrum (RMS) of the sample; wherein the TMS and RMS are compared with respect to encoded spectra and metadata.

In a further aspect, the present disclosure relates to a method for compound QC of a chemical library. In one example, a method comprises: obtaining a reference mass spectrum (RMS) for a selected library member of interest with reference to a target compound, the library member being from a chemical library; analyzing a sample of the selected library member at a time to obtain a test mass spectrum (TMS) representing a quality state of the sample at the time; subtracting background from the RMS and/or the TMS with respect to each selected library member; conducting a full spectral comparison of the TMS against the RMS with respect to each selected library member; generating a comparison metric comprising the comparison of spectra and spectral features; and determining a quality state of the selected library member at the time when the library member is analyzed.

In another example, a method for compound QC of a chemical library comprises: constructing a reference spectral library for a chemical library, the reference spectral library comprising reference mass spectrum with respect to each library member of the chemical library; constructing a test spectral library, the test spectral library comprising corresponding test mass spectrum and extracted spectral features with respect to each library member; subtracting background from the RMS and/or the TMS with respect to each selected library member; conducting a full spectral comparison of the test spectral library against the reference spectral library with respect to each library member; generating a comparison metric comprising the comparison of spectra and spectral features with respect to each library member; determining a quality state of each selected library member at the time when the library member is analyzed; and optionally determining an overall quality of the chemical library.

The details of one or more techniques are set forth in the accompanying drawings and the description below. Other features, objects, and advantages of these techniques will be apparent from the description, drawings, and claims.

### BRIEF DESCRIPTION OF THE DRAWINGS

FIG. 1 is a schematic diagram illustrating one exemplary mass analysis system 100 in accordance with various aspects and embodiments of the present disclosure.

FIG. 2 depicts a schematic view of an example system combining an acoustic droplet ejection (ADE) system with an open-port interface (OPI) and an ion source.

FIG. 3 is a schematic diagram illustrating one particular example of the computing device 200 in accordance with various aspects and embodiments of the present disclosure.

FIG. 4 is a schematic diagram illustrating one particular example of the data processing system 300 in accordance with various aspects and embodiments of the present disclosure.

FIG. 5 is a schematic diagram illustrating one particular example of the data handling module 310 and various operational functions thereof in accordance with various aspects and embodiments of the present disclosure.

FIG. 6 is a schematic diagram illustrating one particular example of the mass spectra analysis module 320 and various operational functions thereof in accordance with various aspects and embodiments of the present disclosure.

FIG. 7 is a schematic diagram illustrating one particular example of the spectral feature extraction module 330 and various operational functions thereof in accordance with various aspects and embodiments of the present disclosure.

FIG. 8 is a schematic diagram illustrating one particular example of the spectral comparison module 340 and various operational functions thereof in accordance with various aspects and embodiments of the present disclosure.

FIG. 9 is a schematic diagram illustrating one particular example of the quality assessment module 350 and various operational functions thereof in accordance with various aspects and embodiments of the present disclosure.

FIG. 10 illustrates one example of the GUI screen showing results generated from spectral comparison, in accordance with various aspects and embodiments of the present disclosure.

FIG. 11 illustrates an example of PCA result of spectral comparison, according to FIG. 10.

FIG. 12(a) illustrates one example of similarity score calculated from spectral comparison, in accordance with various aspects and embodiments of the present disclosure.

FIG. 12(b) illustrates another example of similarity score calculated from spectral comparison, in accordance with various aspects and embodiments of the present disclosure.

FIG. 13 illustrates a flow diagram of a method for assessing quality of a mass spectrum of a sample, in accordance with various aspects and embodiments of the present disclosure.

FIG. 14 illustrates a flow diagram of a particular example of operation 450 of FIG. 13, in accordance with various aspects and embodiments of the present disclosure.

FIG. 15 illustrates a flow diagram of a particular example of operation 470 of FIG. 13, in accordance with various aspects and embodiments of the present disclosure.

FIG. 16 illustrates a flow diagram of one example method for determining quality state of a sample, in accordance with various aspects and embodiments of the present disclosure.

FIG. 17 illustrates a flow diagram of a particular example of operation 510 of FIG. 16, in accordance with various aspects and embodiments of the present disclosure.

FIG. 18 illustrates a flow diagram of one example method for quality control of a chemical library, in accordance with various aspects and embodiments of the present disclosure.

FIG. 19 illustrates a flow diagram of another example method for quality control of a chemical library, in accordance with various aspects and embodiments of the present disclosure.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Definitions and Interpretations for Selected Terms

For the purposes of interpreting this specification, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It will be appreciated that the terms “comprising,” “comprises,” and “comprised of” as used herein comprise the terms “consisting of,” “consists,” and “consists of.”

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6, or ≥7, etc. of said members, and up to all said members.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure, and form different embodiments, as would be understood by those in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

### System for Mass Analysis

The present disclosure relates generally to systems, methods, and workflows for sample analysis through the use of mass spectrometry, in particular, quality assessment of mass spectra, spectral comparison, assessment of sample qualities, spectral library construction, quality control of a chemical library.

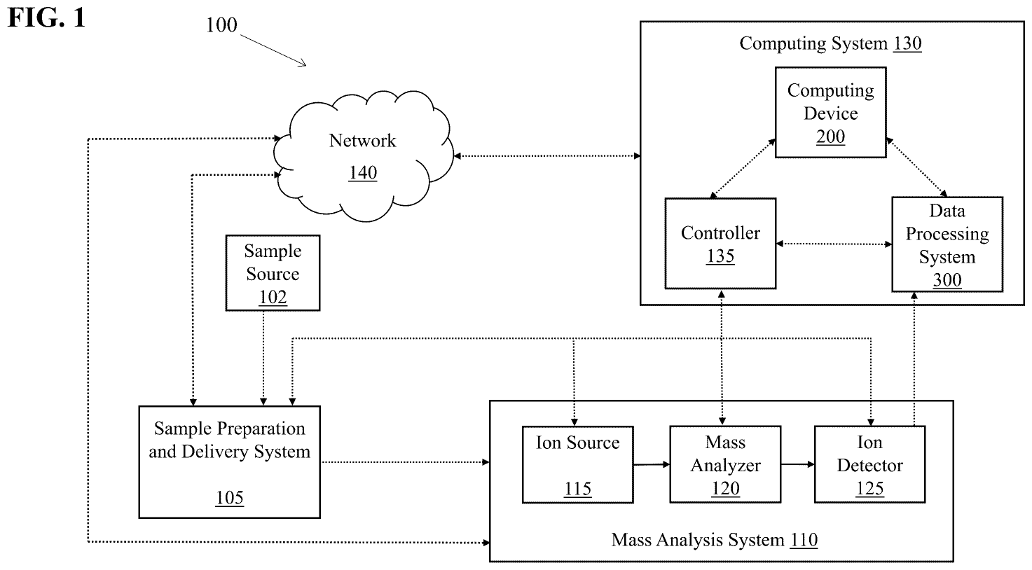

In one aspect, the present disclosure provides systems and methods for analyzing a sample to assess quality of mass spectra obtained from the sample analysis and to determine a quality state of the sample. FIG. 1 illustrates a schematic diagram of one particular example of the present system. In the illustrated example, the system 100 includes a sample source 102, a sample preparation and delivery system 105, a mass analysis system 110, a computing system 130, and optionally a network 140.

The sample source 102 of FIG. 1 includes one or more samples. In some examples, the sample source is a collection or pool of samples each housed in a well of a well plate. In some examples, the sample source contains pluralities of collections of samples, the samples containing selected members of interest from a chemical library. A “chemical library” as used herein refers to a chemical compound library consisting of a collection of stored member chemicals usually used ultimately in screening or industrial manufacture. The chemical library can consist in simple terms of a series of stored chemicals. Each member chemical has associated information such as the target compound, chemical name and structure of the target compound, initial purity, initial quantity, and physiochemical characteristics of the target compound. The chemical library may be established from a combinatorial reaction system for screening reaction conditions of a particular chemical reaction, with each library member comprising a reaction mixture derived from the same reagents under various designed reaction conditions. In such embodiments, the library members may be associated with a common target compound, such as the intended product of the reaction.

The sample analyzed by the system 100 of FIG. 1 may be prepared by conventional techniques. A sample may contain one or more analytes. The analytes of the sample may include one or more target compounds or compounds of interest. In some examples, the sample may also include a sample matrix that contains everything else except the target compounds. For example, the sample matrix may contain a solvent, an impurity, a contaminant, one or more compounds from the environment (e.g., blood, urine, cell culture medium, etc.) where the sample is derived from, an interfering compound, a degradation product of the target compound, a deterioration product of the targe compound, an internal reference or standard, one or more assisting agents that are added to the sample to assist in sample analysis. In some examples, the sample is free from biological or environmental matrices. The quality of the sample may be determined with reference to the target compound(s).

The sample preparation and delivery system 105 of FIG. 1 is operative to receive the sample from the sample source, transport and deliver the sample in appropriate form to the mass analysis system 110. In a particular example, the sample preparation and delivery system 105 comprises an acoustic droplet ejection (ADE), open-port interface (OPI), mass spectrometry (MS) system (hereinafter ADE-OPI-MS). The ADE-OPI technology relies on acoustic dispensing of droplets directly from the wells of the plate under analysis. The acoustically dispensed droplets, which are at nanoliter scale, with the precise control and independent of the sample solvent, are acoustically ejected from the ejected sample and introduced to a vortex at the opening of the OPI and delivered directly to the electrospray ionization (ESI) source of the MS for detection. The extremely small samples required, coupled with the method's resilience in handling unpurified samples, make this technology ideally suited for direct sampling from the well plate. The ADE-OPI-MS system and method also offer significant speed advantages: with an average analysis time of 1-2 s per sample, such that a typical 384-well plate can be analyzed in under 15 min. Finally, the ADE-OPI is compatible with both nominal and high resolution mass spectrometers, allowing rapid quantification with the former, and extensive analyte identification with the latter.

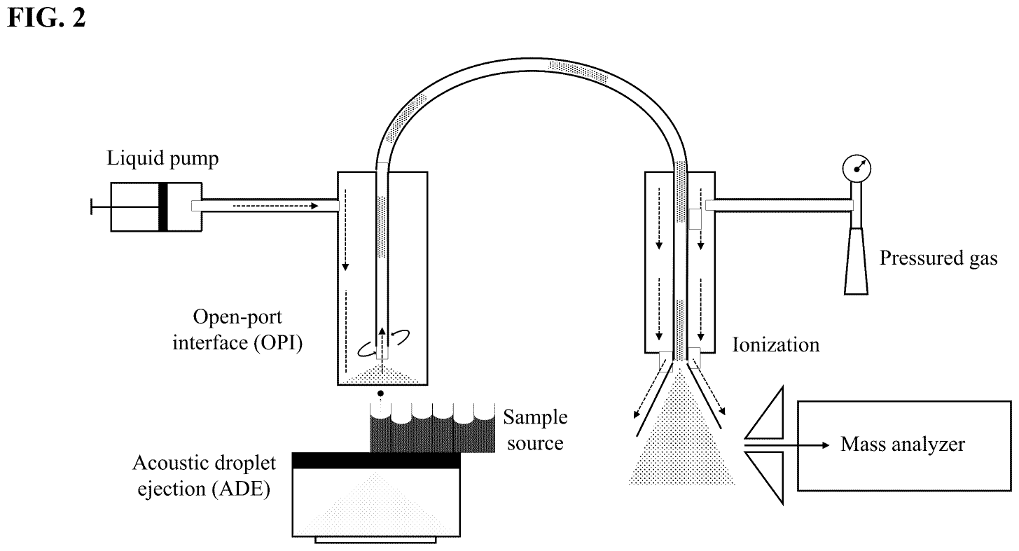

FIG. 2 illustrates a general scheme of an example ADE-OPI-MS system. Briefly, a pulse of acoustic energy ejects sample droplets (1-10 nL) upward into the inverted OPI sampling interface. A fluid pump delivers carrier solvent (100-2,000 μL/min) to a sample capture region equipped with a flow-stabilized vortex interface; sample is captured and diluted into a vortex of flowing carrier solvent. A high voltage (HV) supply and nebulizing gas (nitrogen) at the spray capillary drive ionization such as ESI. More examples of ADE-OPI-MS can be found in U.S. Pat. No. 10,770,277, the disclosure of which is incorporated by reference herein in its entirety.

The mass analysis system 110 of FIG. 1 includes an ion source 115, a mass analyzer 120, and an ion detector 125. The mass analysis system 110 can be operative, for example through use of ion source(s) or generator(s) 115 produce sample ions and to filter and detect selected ions of interest from the sample ions through the use of the ion detector 125. The mass analyzer 120 is operative to analyze the sample ions and produce a mass spectrometry dataset comprising all m/z signals from the sample ions. The generated mass spectrometry dataset may be in a form of a total ion current (TIC) chromatogram.

It will also be appreciated by a person skilled in the art and in light of the teachings herein that the mass analyzer 120 can have a variety of configurations. Generally, the mass analyzer 120 is configured to process (e.g., filter, sort, dissociate, detect, etc.) sample ions generated by the ion source 115. By way of non-limiting example, the mass analyzer 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization source 115 and the mass analyzer detector 120 and is configured to separate ions based on their mobility difference between in high-field and low-field). Additionally, it will be appreciated that the mass analyzer 120 can comprise an ion detector 125 that can detect the ions that pass through the analyzer 120 and can, for example, supply a signal indicative of the number of ions per second that are detected.

The computing system 130 of FIG. 1 comprises computing resources, components, and modules that are operative to perform various functions including but not limited to: communicating with other components of the system 100, receiving and transmitting electrical signals with other components, receiving, responding to, and executing user instructions, performing calculations, processing raw mass spectrometry data received from the mass analysis system 110, analyzing mass spectrometry data, generating and analyzing mass spectra for the samples, identifying, annotating, and assigning MS peaks of mass spectra, extracting spectral features from mass spectra, conducting spectral comparison, identifying analytes, calculating quality score for the mass spectra, determining a quality state of the sample, and outputting analytical report to end users.

The computing system 130 includes a computing device 200, a controller 135, and a data processing system 300. The computing device 200 may be in the form of electronic signal processors and operative to perform various computing functions. The controller 135 may be in the form of electronic signal processors and in electrical communication with other subsystems within the system 100. The controller 135 is further configured to coordinate some or all of the operations of the pluralities of the various components of the system 100. The data processing system 300 may include various components and modules operative to process mass spectrometry data.

A network 140 may be operably connected to any one or all of the subsystems or components in the system 100. The network 140 is a communication network. In the exemplary embodiment, the network 140 is a wireless local area network (WLAN). The network 140 may be any suitable type of network and/or a combination of networks. The network 140 may be wired or wireless and of any communication protocol. The network 104 may include, without limitation, the Internet, a local area network (LAN), a wide area network (WAN), a wireless LAN (WLAN), a mesh network, a virtual private network (VPN), a cellular network, and/or any other network that allows the computing system 130 to operate as described herein.

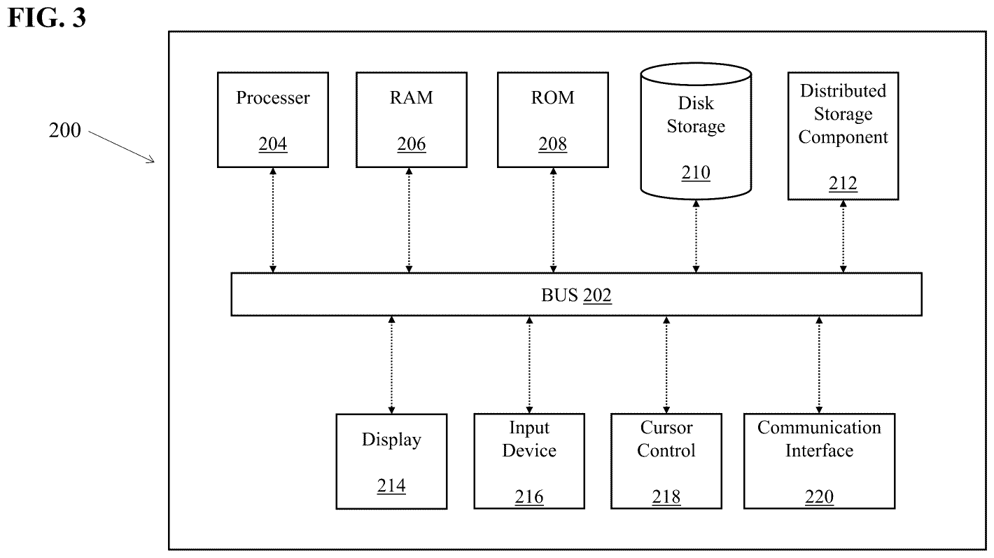

Now referring to FIG. 3, an example of the computing device 200 according to FIG. 1 will be illustrated and described. It is noted that the computing system 130 of the system 100 may comprise a single computing device 200 or may comprise a plurality of distributed computing devices 200 in operative communication with components of a mass analysis system 110. In the illustrated example of FIG. 3, the computing device(s) 200 may include a bus 202 or other communication mechanism of similar function for communicating information, and at least one processing element 204 coupled with bus 202 for processing information. As will be appreciated by those skilled in the relevant arts, such at least one processing element 204 may comprise a plurality of processing elements or cores, which may be packaged as a single processor or in a distributed arrangement. Furthermore, a plurality of virtual processing elements 204 may be included in the computing device 200 to provide the control or management operations for the mass analysis system 110.

The computing device 200 may also include one or more volatile memory(ies) 206, which can for example include random access memory(ies) (RAM) or other dynamic memory component(s), coupled to one or more busses 202 for use by the at least one processing element 204. Computing device 200 may further include static, non-volatile memory(ies) 208, such as read only memory (ROM) or other static memory components, coupled to busses 202 for storing information and instructions for use by the at least one processing element 204. A storage component 210, such as a storage disk or storage memory, may be provided for storing information and instructions for use by the at least one processing element 204. As will be appreciated, the computing device 200 may comprise a distributed storage component 212, such as a networked disk or other storage resource available to the computing device 200.

The computing device 200 may be coupled to one or more displays 214 for displaying information to a computer user. Optional user input devices 216, such as a keyboard and/or touchscreen, may be coupled to a bus for communicating information and command selections to the at least one processing element 204. An optional graphical input device 218, such as a mouse, a trackball or cursor direction keys for communicating graphical user interface information and command selections to the at least one processing element. The computing device 200 may further include an input/output (I/O) component, such as a serial connection, digital connection, network connection, or other input/output component for allowing intercommunication with other computing components and the various components of the mass analysis system 110.

In various embodiments, computing device 200 can be connected to one or more other computer systems a network to form a networked system. Such networks can for example include one or more private networks, or public networks such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. Various operations of the mass analysis system 110 may be supported by operation of the distributed computing systems.

The computing device 200 may be operative to control operation of the components of the mass analysis system 110 and the sample preparation and delivery system 105 through a communication interface 220, and to handle data generated by components of the mass analysis system 110 through the data processing system 300. In some examples, analysis results are provided by computing device 200 in response to the at least one processing element 204 executing instructions contained in memory 206 or 208 and performing operations on data received from the mass analysis system 110. Execution of instructions contained in memory 206 or 208 by the at least one processing element 204 can render the mass analysis system 110 and associated sample delivery components operative to perform methods described herein.

The term “computer-readable medium” as used herein refers to any media that participates in providing instructions to processor 204 for execution. Such a medium may take many forms, including but not limited to, non-volatile media, volatile media, and transmission media. Non-volatile media includes, for example, optical or magnetic disks, such as disk storage 210. Volatile media includes dynamic memory, such as memory 206. Transmission media includes coaxial cables, copper wire, and fiber optics, including the wires that comprise bus 202.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 204 for execution. For example, the instructions may initially be carried on the magnetic disk of a remote computer. The remote computer can load the instructions into its dynamic memory and send the instructions over a telephone line using a modem. A modem local to computing device 200 can receive the data on the telephone line and use an infra-red transmitter to convert the data to an infra-red signal. An infra-red detector coupled to bus 202 can receive the data carried in the infra-red signal and place the data on bus 202. Bus 202 carries the data to memory 206, from which processor 204 retrieves and executes the instructions. The instructions received by memory 206 may optionally be stored on storage device 210 either before or after execution by processor 204.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is noted that the described implementation includes software but the present teachings may be implemented as a combination of hardware and software. The present teachings may be implemented with both object-oriented and non-object-oriented programming systems.

### Data Processing System for Spectral Comparison and Quality Assessment

In another aspect, the present disclosure relates to data processing systems and methods of using the same for spectral comparison and quality assessment of samples. As discussed above, the present system 100 may include a data processing system 300 operative to process mass spectrometry data generated from sample analysis and to conduct mass spectral analysis and comparison. The present system 100 may be operative to analyze a large collection of samples or members selected from a large chemical library in a high throughput fashion, through the use of ADE-OPI-MS. Accordingly, the data processing system 300 described herein may be operative to conduct spectral analysis to assess sample quality of a large collection of samples in a high throughput fashion.

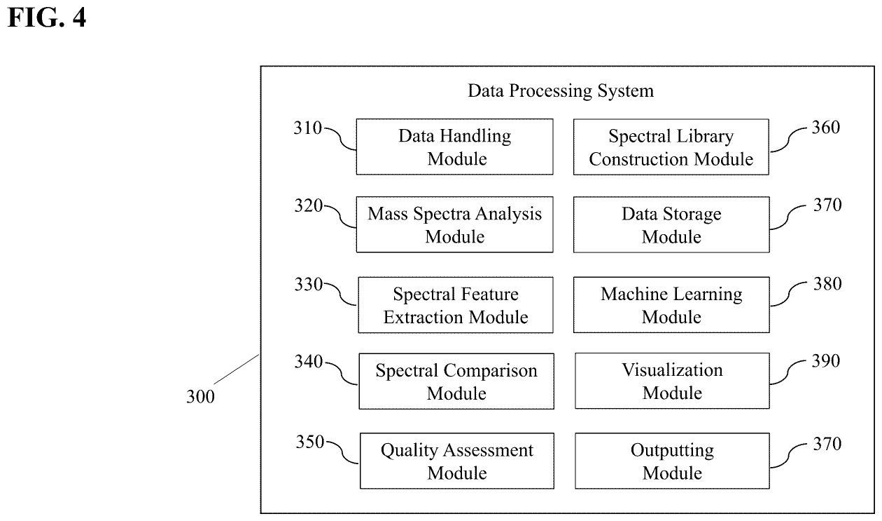

Now referring to FIGS. 4-9, particular examples of the data processing system 300 and various aspects thereof will be illustrated and described in detail. FIG. 4 illustrates a schematic view of one example of the data processing system 300 according to FIG. 1. In the illustrated example, the data processing system 300 includes one or more or all of the following modules: a data handling module 310, mass spectra analysis module 320, a spectral feature extraction module 330, a spectral comparison module, a quality assessment module 350, a spectral library construction module 360, a data storage module 370, a machine learning module 380, a visualization module 390, and an outputting module 395. The various modules included in the data processing system 300 may be operatively connected or interconnected among each other. Each module of the data processing system 300 may be operatively connected to other components or subsystems of the system 100 according to FIG. 1.

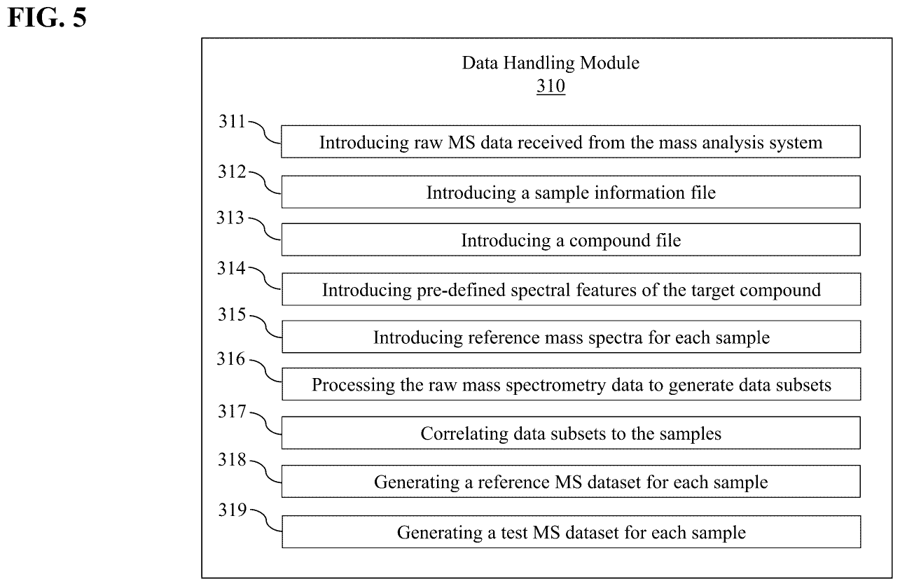

FIG. 5 illustrates one particular example of the data handling module 310 of FIG. 4. In the illustrated example, the data handling module 310 is operative to conduct one or more or all of operations 311-319. Operation 311 includes introducing raw mass spectrometry data received from a mass analysis system 110. As discussed above, the raw mass spectrometry data generated by the mass analysis system 110 may be in a form of a single, large dataset (such as a TIC) consisting of all m/z signals of the sample ions derived from a full scan of all samples. Upon completion of sample analysis within the mass analysis system 110, the raw mass spectrometry dataset is sent to the computing system 130 and received by the data processing system 300.

The data handling module 310 may be further operative to introduce a sample information file at 312. The sample information file may include: sample preparation information (solvent, concentration, etc); sample origination information (library member ID of the sample in a chemical library, lot No., run No., etc.); test/instrument condition for each sample, scan No., time information of each sample (time of sample ejection, time of sample introduction, time of scan, etc.), well position (sample ID) of each sample, etc. In some examples, the sample information file is associated with the raw mass spectrometry data, which may be introduced altogether at 311.

The data handling module 310 may be further operative to introduce a compound file with respect to each test sample at 313. The compound file may include a standard or reference mass spectrum, chemical formula, theoretical molecular mass, expected m/z peaks, expected mass spectral features, internal fragmentation features, fingerprint features, MS/MS features, or other chemical knowledge related to the target compound with respect to each sample. The compound file may further include information regarding possible interfering compounds related to the target compound, including but not limited to sample matrix compounds, degradation products, deterioration products, metabolites, derivatives, reaction by-products, etc.

The data handling module 310 may be further operative to introduce pre-defined spectral features or attributes of the target compound at 314. The pre-defined spectral features or attributes are indicative of a quality state of the sample with reference to the target compound. Non-limiting examples of the predefined feature include: expected m/z value for the target compound; intensity of the peak at expected m/z value for the target compound; fingerprint spectral feature of the target compound, spectral feature indicative of interference and/or amount of interference, spectral feature indicative of degradation or deterioration of the target compound. The spectral features or attributes may be defined or established by standard or reference spectra of the target compound, or a priori knowledge from previous analysis, or existing data from previous quality assessment, etc.

The data handling module 310 is further operative to introduce one or more reference mass spectra for each sample at 315. The reference mass spectra may be obtained by analysis of a sample at high purity or high quality state.

The data handling module 310 may be operative to automatically process the raw mass spectrometry data at 316 to generate data subsets corresponding to each sample. As discussed above, when analyzing a large collection or pool of samples, the resulted raw mass spectrometry data may be a single, large, and unsplit dataset. In such situations, the data handling module may be operative to split the dataset into data subsets, with each data subset corresponding to each sample.

The data handling module 310 may be further operative to correlate each data subset generated at to the corresponding sample at 317. The sample-dataset correlation may be based on the time information recorded in the log. The time information includes but is not limited to: timing of ejection for each test sample from the well plate, timing of the introduction of ejected sample droplet into the mass analysis system, and timing of the start and end of the m/z scan, etc. Such time information may be introduced into the data processing system at 312.

The data handling module 310 may be further operative to generate a reference MS dataset for each sample at 318 and/or to generate a test MS dataset for each sample at 319. The reference MS dataset may include one or more or all of the following information with respect to each sample: target compound information, reference mass spectrum (RMS), pre-defined spectral features indicative of the sample quality. The test MS dataset may include one or more or all of the following with respect to each sample: the sample information, compound file, test mass spectrum, spectral features extracted from the test mass spectrum.

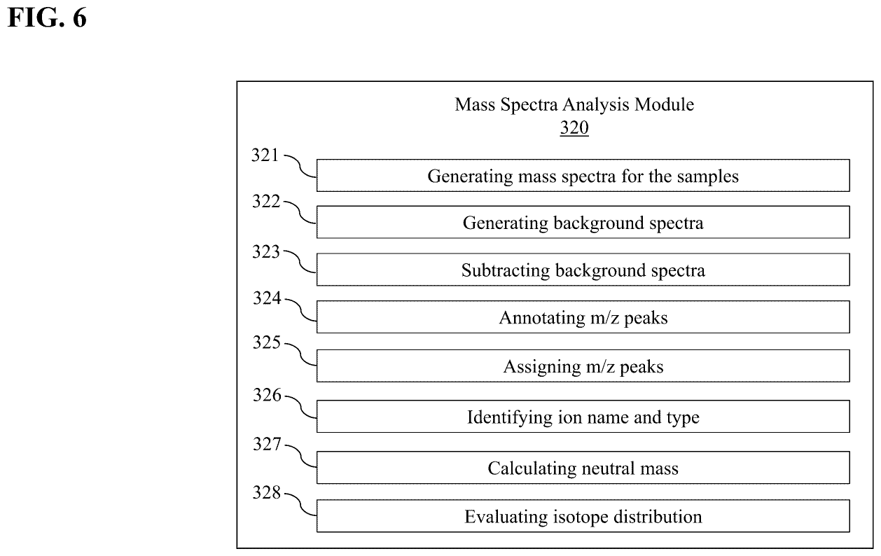

FIG. 6 illustrates one particular example of the mass spectra analysis module 320 of FIG. 4. In the illustrated example, the mass spectra analysis module 320 is operative to conduct one or more or all of operations 321-328. The mass spectra analysis module 320 may be operative to generate a mass spectrum for each sample at 321. For example, the split data subset generated from the data handling module 310 can be directly converted into a mass spectrum of the correlated sample. Each mass spectrum includes the m/z signals of all ionization products derived from the correlated sample over the entire m/z range.

The mass spectra analysis module 320 may be operative to generate a background mass spectrum. As discussed above, the raw mass spectrometry dataset (such as TIC) may contain both signals derived from the test samples and background or noise. In some examples, the data processing system 300 is operative to remove the background or background signals from the mass spectrum. The background mass spectrum may be derived from analysis of a blank sample, e.g., a blank well, a solvent, or a control that is free from the test sample or a target compound. The background mass spectrum may include selected m/z peaks known to be background or noise signals, or m/z peaks from carrier flow ions, or m/z peaks from solvent, m/z peaks from impurities, m/z peaks from the sample matrix, m/z peaks from interfering compounds, degradation and deterioration products of the target compound associated with the sample. The background signals may also be determined by data points acquired at the acquit ion time when no sample ion is detected and the signal is majorly derived from the mobile phase.

The mass spectra analysis module 320 may be further operative to subtract the background mass spectrum or background signals from the original mass spectrum of each sample to obtain a background-subtracted mass spectrum for each test sample. Background subtraction may advantageously improve the quality of the mass spectrum and the accuracy of peak assignment and analyte identification.

It is noted that, most existing spectral analysis algorithms are based on data dependent acquisition (DDA) analysis of MS2 spectra using liquid chromatography mass spectrometry (LC-MS). So there is assumption that LC would separate background signals and impurities and even if present, it assumes impurity ions will be at lower intensity level than ions related to target compound because DDA would to trigger MS2 close to the apex of the target compound LC peak where impurity LC peak is hopefully at lowest abundance with respect to the target ions.

As described herein, the present system may employ an ADE-OPI-MS system for high throughput analysis of samples. By the nature of OPI, the presence of noises from flow carrier and solvent ions cannot be avoided. However, the background noises from these ion types can be effectively removed by background subtraction. For example, carrier solvent background may be estimated from the local minima before and after the peak of interest, to avoid possible imperfections of window splitting. In such data, “blank well” is not acquired, but in future sample analysis, sample background could be characterized and identified from the test mass spectrum. The resulted background-subtracted mass spectra may include mostly peaks related to the target compound or compound of interest and can provide information of compound degradation and/or deterioration, and internal or insource fragmentation.

In other exemplary embodiments, the mass spectra analysis module is further operative to conduct the following operations: annotating m/z peaks of the resulted mass spectra at 324, assigning m/z peaks at 325, identifying ion name and type for m/z peaks of interest at 326, calculating neutral mass including but not limited to average mass, monoisotopic mass, most abundant mass, mass shift or difference, charge state at 327; evaluating/quantifying isotope distribution of a peak of interest at 328.

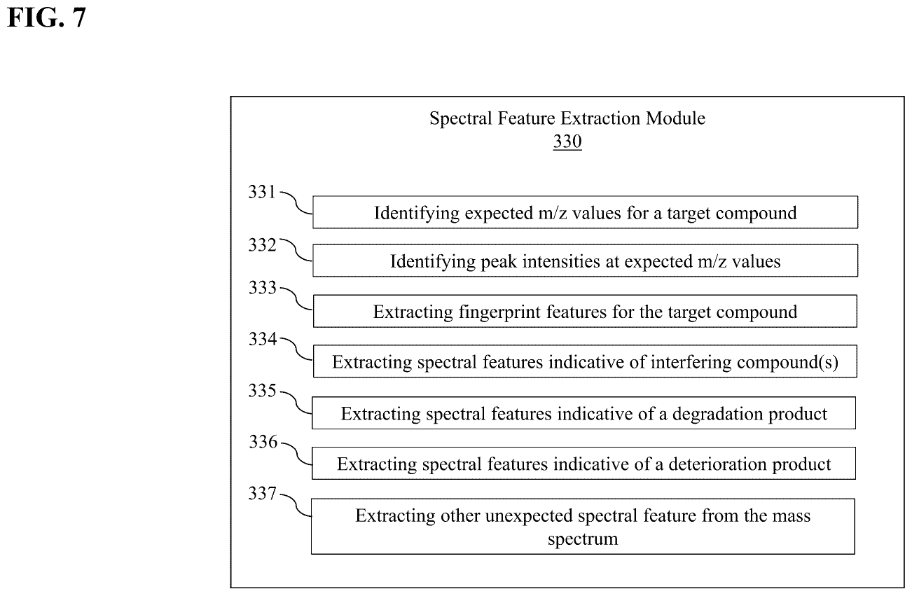

FIG. 7 illustrates a particular example of the spectral feature extraction module 330 of FIG. 4. In the illustrated example, the spectral feature extraction module 330 is operative to perform one or more or all of operations 331-337. The module 330 may be operative to identify expected m/z values of a target compound from the mass spectrum of the sample at 331; and/or to identify peak intensities at expected m/z values of the target compound at 332. The target compound may have one characteristic m/z peak (e.g., an anchor peak) affirmative of the presence of the target compound. The target compound may have a series of characteristic m/z peaks in collection indicating the presence of the target compound. In some examples, the expected m/z peaks may have a characteristic ratio of peak intensities indicative of the presence of the target compound.

The spectral feature extraction module 330 may be further operative to extract spectral features from the mass spectra of the samples at operations 333-337. For example, fingerprint features indicative of the target compound may be extracted from the mass spectra of the samples at 333. The fingerprint feature may be extracted from one or more or all of the following: the annotated m/z peaks, mass or m/z difference relationship between or among peaks, relative intensity of MS peaks, or any characteristic relationship between or among ion types, ion species, or ion products, isotopic clusters at varying charge states that share a common neutral mass, isotope distribution pattern, internal fragmentation, insource fragmentation, etc. The fingerprint features may be indictive of the presence, absence, relative quantity, relative purity, or a quality state of the target compound in the sample.

The module 330 may be further operative to conduct one or more or all of the following operations: extracting spectral features indicative of interfering compounds at 334; extracting spectral features indicative of a degradation product of the target compound at 335; extracting spectral features indicative of a deterioration product of the target compound at 336; extracting other unexpected spectral features from the mass spectrum at 337. Extraction of various spectral features from the mass spectrum as described herein advantageously provides users a comprehensive analysis of the sample, including not only the characteristic or expected m/z peaks of the target compound, but also more details about the background and sample matrix, which helps users to more accurately assess the quality of the sample. In addition, extraction of spectral features from the mass spectrum is helpful for users to conduct comprehensive comparison between or among mass spectra, e.g., through the use of the spectral comparison module 340, which will be described below.

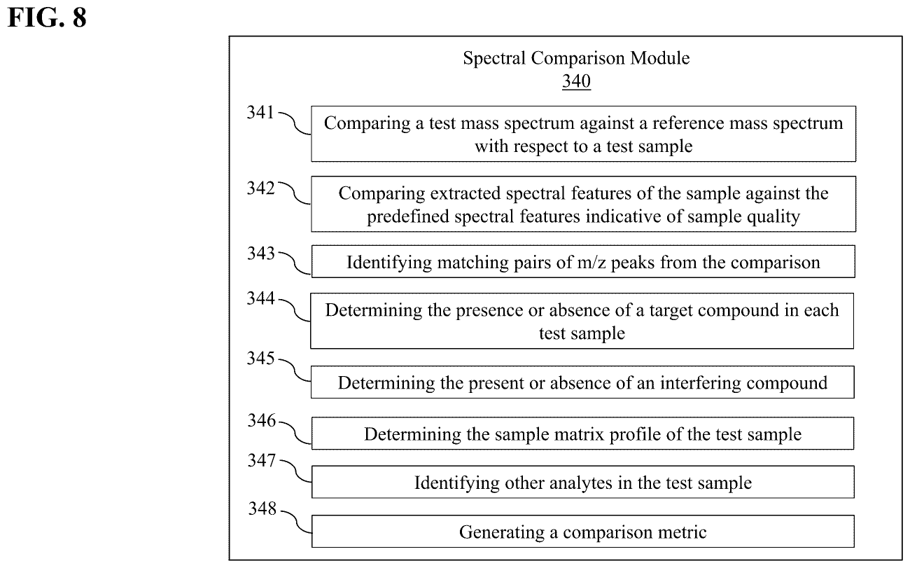

FIG. 8 illustrates a particular example of the spectral comparison module 340 of FIG. 4. The spectral comparison module 340 according to the present disclosure advantageously provides users a means to comprehensively compare, map, and analyze quality between or among spectra with respect to a sample. As discussed previously, a reference mass spectrum (RMS) may be obtained from analysis of a target compound associated with the sample or an ascertained sample with high degree of purity or quality with reference to the target compound. A test mass spectrum (TMS) may be obtained by analysis of the sample at a time when the quality of the sample is to be determined. By comparison of the test mass spectrum against the reference mass spectrum, a quality state of the sample at the time when it is analyzed can be determined.

In the illustrated example of FIG. 8, the spectral comparison module 340 is operative to perform one or more or all of operations 341-348. Operation 341 includes comparing a test mass spectrum (TMS) against a reference mass spectrum (RMS) with respect to a test sample. The test mass spectrum may be an original test mass spectrum or a background-subtracted test mass spectrum as described above. Similarly, the reference mass spectrum may be an original mass spectrum or a background-subtracted reference mass spectrum. It is noted that by using the ADE-OPI-MS system described herein, the quality of the mass spectra can be significantly improved by canceling out the background or the sample matrix signals in the mass spectra, leaving primarily the characteristic m/z peaks. Accordingly, comparison of the background-subtracted mass spectra may provide users direct information regarding the change of the characteristic m/z peaks indicative of the quality change of the sample absent the background noises. In some examples, more than one test mass spectra are compared with the reference mass spectrum, each test mass spectrum obtained by analyzing the same sample at a different time. Accordingly, the comparison among the spectra may provide users the quality change of the same sample over time. The ability of spectral comparison among mass spectra using the systems and methods described herein may advantageously provide users a time-efficient solution to monitoring quality change of selected chemical members of interest in a million-sized chemical library.

Operation 342 includes comparing extracted spectral features of the sample against the predefined spectral features indicative of sample quality. As discussed above, various spectral features may be extracted from the reference mass spectrum and the test mass spectrum with respect to each sample. Accordingly, the extracted spectral features can be compared directly to the predefined spectral features, e.g., expected m/z value of the target compound, fingerprint features indicative of the presence or absence or relative quantity of the target compound, etc. The predefined spectral features or attributes indicative of the target compound or quality thereof may be obtained from established chemical knowledge, a priori information from previous analysis, or standard mass spectral information from authoritative sources.

Operation 343 includes identifying matching pairs of m/z peaks in spectral comparison. The spectral comparison may include a comparison between a reference mass spectrum and a test reference mass spectrum with respect to the sample, or a comparison between a mass spectrum of the sample with predefined spectral features. In some examples, the presence of matching pairs of m/z peaks at expected m/z values are determinative of the presence of the target compound and/or a quality state of the sample. In other examples, matching pairs of a series of characteristic m/z peaks are needed to confirm the presence or absence of the target compound in the sample.

Operation 344 includes determining the presence or absence of a target compound in each test sample, based on the comparison of the test mass spectrum of the sample to the reference mass spectrum thereof as described above.

Operation 345 includes determining the present or absence of an interfering compound in the test sample. In some examples, the determination at 345 is based on the comparison of a test mass spectrum against a reference mass spectrum with respect to the extracted features indicative of interfering compounds, degradation compounds, deterioration products, or sample matrix generated by the spectral feature extraction module 330.

Operation 346 includes determining sample matrix profile of the test sample, based on the comparison of the extracted spectral features with respect to the test sample. The sample matrix profile may include one or more or all of the following: surrounding compounds indicative of the environment where the sample is derived from, impurities, contaminants, internal fragments, in-source fragments, interfering compounds, degradation products of the target compound, deterioration products of the target compound, metabolites of the target compound, derivatives of the target compound, etc.

Operation 347 includes identifying other analytes in the test sample relevant or irrelevant of the sample quality. Operation 348 includes generating a comparison metric comprising any result generated from the spectral comparison module 340.

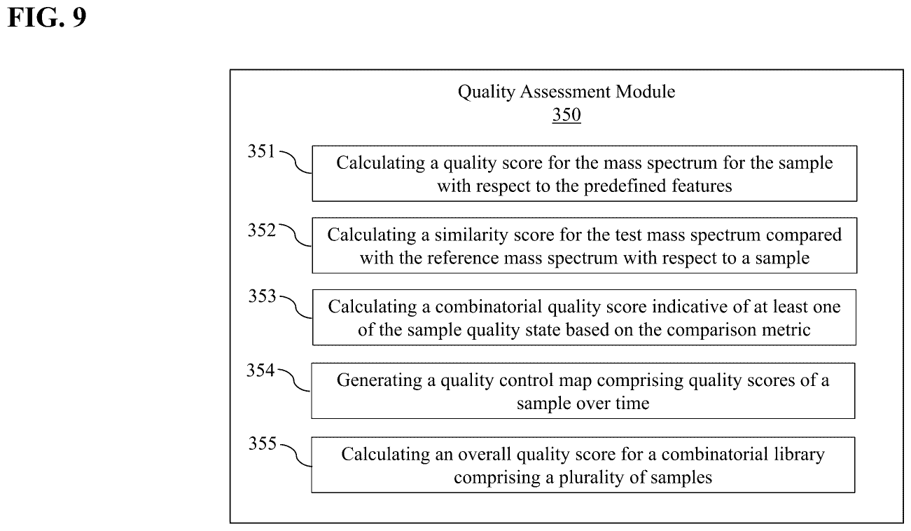

FIG. 9 illustrates a particular example of the quality assessment module 350 of FIG. 4. In the illustrated example, the quality assessment module 350 includes one or more or all of operations 351-355. Operation 351 includes calculating a quality score for the mass spectrum for the sample with respect to the predefined features indicative of at least one quality state of the sample with reference to a target compound. A mass spectrum of a sample may be designated as a reference mass spectrum of that sample if a sufficiently high quality score is calculated for the mass spectrum. Operation 352 includes calculating a similarity score for the test mass spectrum, compared against a reference mass spectrum with respect to the sample. The similarity score may reflect a quality change of the sample relative to the reference mass spectrum. In some examples, various similarity scores may be calculated with respect to both the original mass spectra and the background-subtracted mass spectra of the sample. Particular algorithms can be used to subtract the spectral pair with normalized peak intensity with reference to the target m/z or the maximum peak intensity of the spectra. Various intensity transformation could be considered to balance intensity weighting as well as a log-normalization step. Various distance metrics may be considered, including Sum of the Square distances (“Eucledian”) of the signal of the processed spectra, in normal and log scale; sum of the absolute value of the signal of the processed spectra; “DotProd” in normal and log scale; “Chebychev” distance, in normal and log scale; the “Hamming” method considering the percentage of m/z overlap and ignoring intensity (present/not present). In some examples, any operation of the module 350 may further include calculating “signal to noise” ratio (S/N) as a measure of m/z intensity of the ion of interest with respect to background signals (or background spectrum) as well as to remaining ions after background subtraction (e.g., compound ion strength with respect to fragment ions or other compound related ions).

Operation 353 includes calculating a combinatorial quality score indicative of at least one of the sample quality state based on the comparison metric generated through the use of the spectral comparison module 340. The combinatorial quality score may be a weighted average score of all comparisons included in the comparison metric, such as the presence of expected m/z peaks of the target compound, similarity of fingerprint features indicative of the target compound, etc.

Operation 354 includes generating a quality control map comprising quality scores of a sample over time, wherein the each quality score is calculated for the corresponding test mass spectrum of the sample analyzed at particular time point. Operation 354 advantageously provides users a time-efficient and convenient way to monitor the quality change of each member chemical in a large chemical library. Operation 355 includes calculating an overall quality score for a combinatorial library comprising large collection of member chemicals.

Now referring back to FIG. 4, the data processing system 300 may include a spectral library construction module 360 operative to compile the MS dataset and spectral comparison results generated from various modules of the system 300 to construct a spectral library. The module 360 may be operative to generate a reference spectral library comprising reference MS dataset (including reference mass spectrum and extracted spectral features therefrom) for each member of a chemical library. The module 360 may be further operative to generate a test spectral library comprising test MS dataset (including test mass spectrum and extracted spectral features therefrom) for each corresponding member of the chemical library. The spectral information of the spectral libraries may be retrievable, searchable, and processable by users or upon instructions. The data processing system 300 may further include a data storage module 370 operative to store various types of data or results from spectral analysis comparison, and the spectral libraries as described herein.

The data processing system 300 may further include a machine learning module 380 operative to perform any operations of the modules included in the data processing system 300, in a supervised or unsupervised fashion. The machine learning module may include one or more machine learning classifiers operative to extract the critical features from the input data to generate a classification model. Through the use of the machine learning module, the data processing system 300 is operative to conduct spectral comparison and quality assessment with respect to different spectral features and to apply the classification model to future sets of analysis data. A machine learning classifier may be constructed from the extracted spectral feature and the spectral annotation(s). The machine learning classifier may comprise known classifiers that may be applied to the analysis data. For example, fragmentation may be used to generate more robust analysis data indicative of the presence of the target compound or a quality state of the test sample. Accordingly, the classifier model may be trained based on detection of both parent ions and/or daughter ions produced from a sample. Such classifier model may be used in future spectral analysis of the same or similar sample at a different time point.

To generate sufficient data for the classification model to be effective it will require the analysis and comparison of many extracted spectral features through the data processing system. These many forms of extracted spectral features may generated by analysis of a large collection of samples (e.g. from a chemical library). Analysis of each of the large quantity of samples a multitude of times through the data processing system provides data which can then be grouped and passed through a spectral feature reduction unit where data can be preprocessed. The output of the preprocessing unit is combined with other metadata related to features indicative of a quality state of the sample. This data is then passed to a machine learning classifier which is able to extract the critical features from the input data and generate a model to be able to classify the different forms. The machine learning classifier could take on any form of classifier and it may be prudent to also utilize multiple levels of classifier or prediction algorithms to generate a robust system.

A trained machine learning classifier may be operative to predict identification or structure of analytes and determine whether it is the target compound, or an interfering compound, or a mixture of compounds, or other compounds belonging to the sample matrix. The trained machine learning classifier may be further operative to calculate the overall spectral similarity or quality score of the sample based on the comparison.

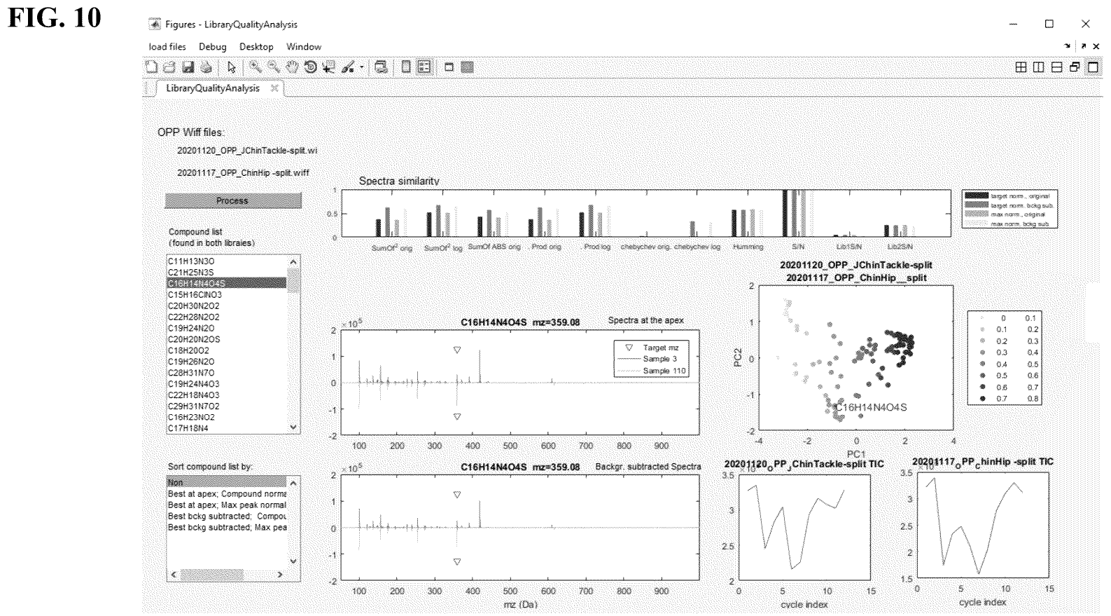

The data processing system 300 may further include a visualization module 390 operative to visualize the processed data or results generated from various modules of the system 300, such as the mass spectra, background-subtracted mass spectra, summary table of extracted features, comparison metric, etc. The visualized results may be displayed in a user interface such as a graphic user interface (GUI) for users to review. FIG. 10 illustrates one example of the GUI screen showing results generated from spectral comparison. In the illustrated example, result review is supported by multivariate analysis using extracted spectral features. The data processing system 300 may optionally include an outputting module 395 operative to output the processed data and any analytical results generated by the data processing system 300.

Spectral comparison and quality assessment described herein may be performed and visualized using the principal component analysis (PCA) technique. Principal component analysis is a multivariate analysis (MVA) tool that is widely used to help visualize and classify data. PCA is a statistical technique that may be used to reduce the dimensionality of a multi-dimensional dataset while retaining the characteristics of the dataset that contribute most to its variance.

PCA can reduce the dimensionality of a large number of interrelated variables by using an eigenvector transformation of an original set of variables into a substantially smaller set of principal component (PC) variables that represents most of the information in the original set. The new set of variables is ordered such that the first few retain most of the variation present in all of the original variables. More particularly, each PC is a linear combination of all the original measurement variables. The first is a vector in the direction of the greatest variance of the observed variables. The succeeding PCs are chosen to represent the greatest variation of the measurement data and to be orthogonal to the previously calculated PC. Therefore, the PCs are arranged in descending order of importance. The number of PCs (n) extracted by PCA cannot exceed the smaller of the number of samples or variables.

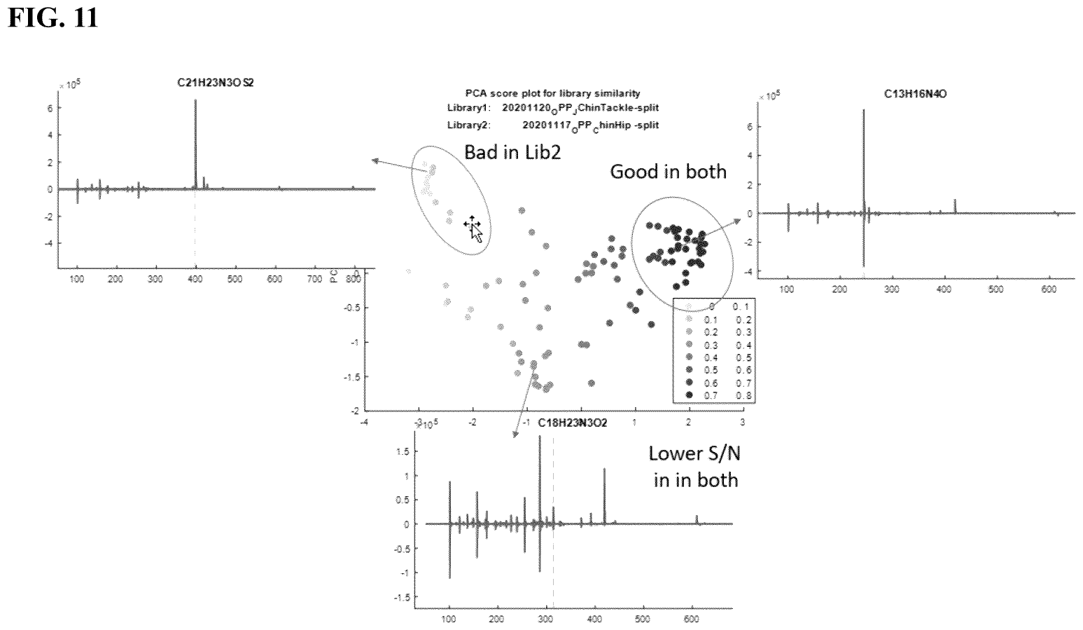

FIG. 11 illustrates an example of PCA result. The illustrate example of FIG. 11 shows a PCA plot of all spectral similarities with respect to a particular sample, according to FIG. 10. Each compound is represented by a dot. The gray level of the dots reflects spectral similarity, as shown in the grayscale table. In the illustrated example, two spectral libraries Lib 1 and Lib 2 are compared with respect to selected samples. As can be seen, the dots having a relatively high gray level reflect samples having good spectral similarity in both Lib1 and Lib2. Comparatively, the dots having a relatively light color reflect samples having bad similarity in Lib2. Other dots correspond to samples with spectral similarity explained by PC1 and quality explained by PC2. The PCA may also identify samples having low S/N in both spectra of Lib 1 and Lib 2. Three examples of mass spectral comparison respectively presenting a “good” similarity, a “poor” similarity, and a “low S/N” are also illustrated in FIG. 11.

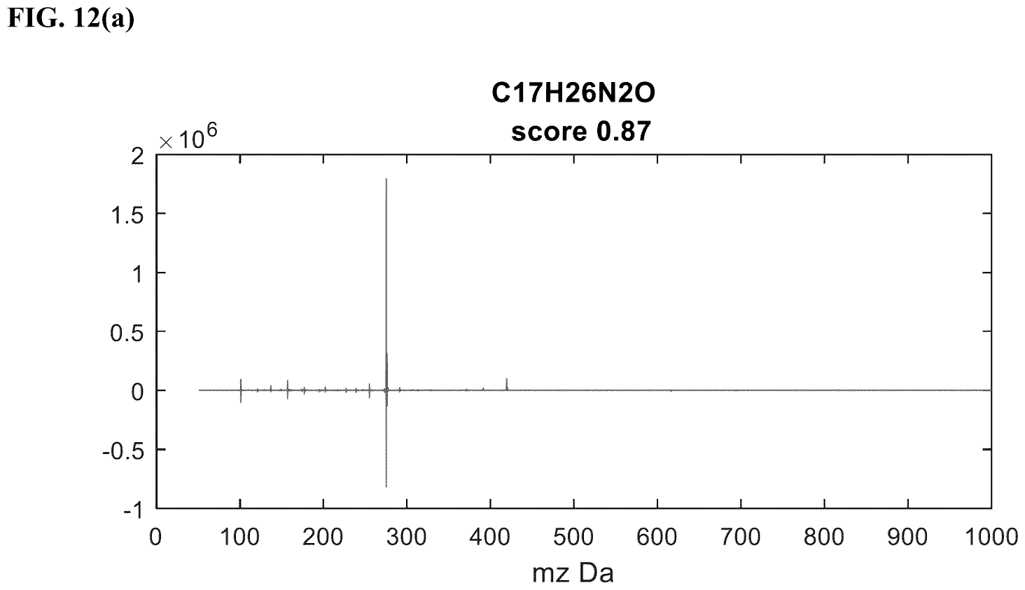

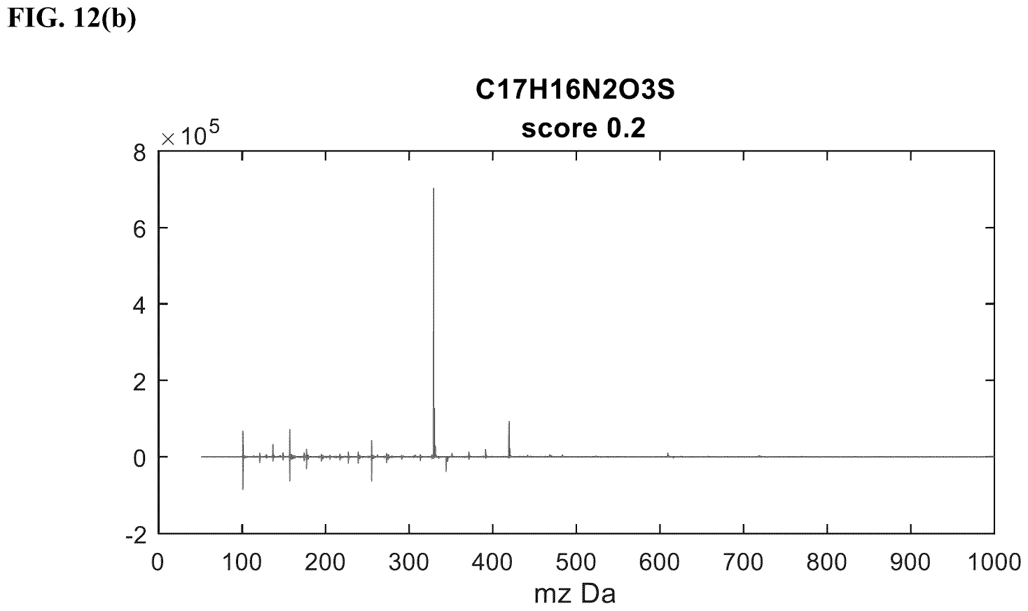

FIGS. 12(a) and 12(b) illustrate examples of similarity score calculated from spectral comparison. FIG. 12(a) shows a relatively “good” spectral similarity (score=0.87) between two spectra of a sample with reference to the compound “C17H26N2O.” FIG. 12(b) shows a relatively “poor” spectral similarity (score=0.2) between two spectra of a sample with reference to the compound “C17H16N2O3S.”

The method of spectral comparison according to the present disclosure may include directly comparing a test mass spectrum of the sample against a corresponding reference mass spectrum from encoded spectra and metadata to produce a combinatorial score indicative of at least one of the sample quality state, without calculating a quality score for the spectrum.

### Methods for Spectral Comparison, Quality Assessment, Chemical Library QC

In another aspect, the present disclosure relates to methods for spectral comparison and quality assessment of mass spectra and test samples. Any methods described herein may be implemented through the use of the system 100 and/or the computing system 130 and/or the data processing system 300 according to the present disclosure.

As discussed above, the present methods may utilize an ADE-OPI-MS system, which is advantageous over the conventional LC-MS based systems. Although LC-MS may separate sample matrix or background from the compound of interest, it usually takes relatively long time, e.g., minutes to deliver a sample from a single well. When analyzing a large collection of samples, e.g., from a large chemical library, the aggregation of over hundreds of compounds may require several hours or even days to analyze a high-density experiment, therefore significantly limiting the throughput or productivity.

Moreover, the ADE-OPI-MS system advantageously allows for capturing a full background mass spectrum of the sample and subtracting the background mass spectrum or background signals from the acquired spectra of the sample in a time-efficient manner. The future test samples can be evaluated against the reference spectrum to accurately pass test samples sampled at high speed or in a high throughput manner using the ADE-OPI-MS system.

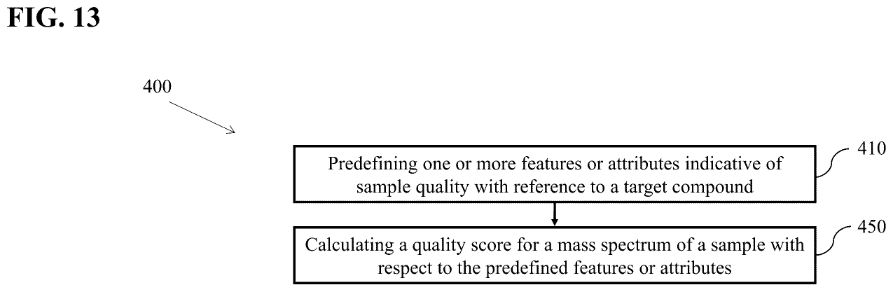

Now referring to FIGS. 13-15, examples of methods for assessing quality of a mass spectrum of a sample and various aspects thereof will be illustrated and described. FIG. 13 illustrates a flow diagram of a method 400. The method 400 includes operations 410 and 450. At 410, one or more features or attributes indicative of sample quality with reference to a target compound are predefined. As discussed above, the predefined features may be selected from the group of: expected m/z value for the target compound; intensity of the peak at expected m/z value for the target compound; fingerprint spectral feature of the target compound, spectral feature indicative of interference and/or amount of interference, spectral feature indicative of degradation or deterioration of the target compound.

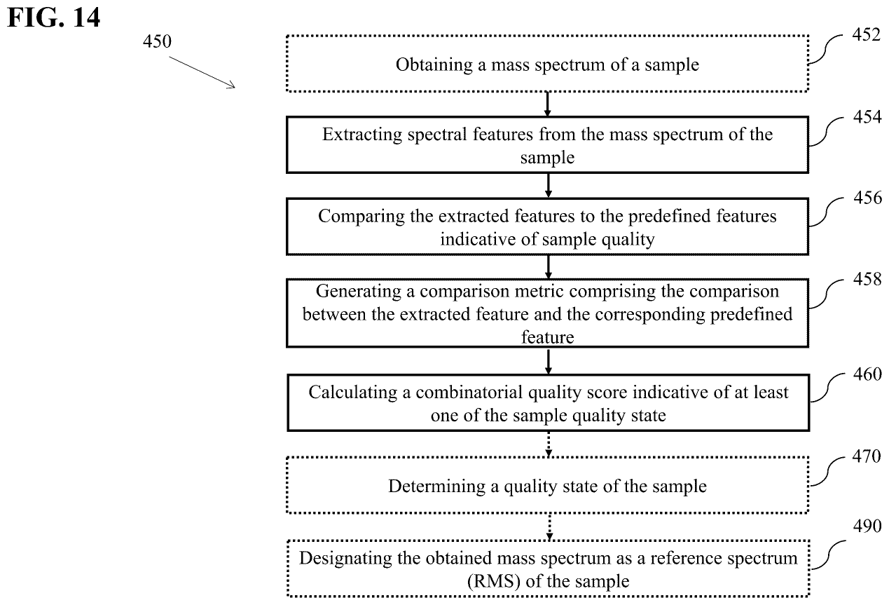

Operation 450 includes calculating a quality score for a mass spectrum of a sample with respect to the predefined features or attributes. FIG. 14 illustrates a flow diagram of one particular example of operation 450 of FIG. 13. In the illustrated example, operation 450 further includes one or more or all of operations 452, 454, 456, 458, 460, 470, and 490. At operation 452, a mass spectrum of a sample of interest is obtained by analyzing the sample, for example, through the use of the system 100. At 454, spectral features are extracted from the mass spectrum of the sample, for example, through the use of the spectral feature extraction module 330. At 456, the extracted features are compared to the predefined features indicative of sample quality, for example, through the use of the spectral comparison module 340. At 458, a comparison metric is generated, for example, through the use of the quality assessment module 350. At 460, a combinatorial quality score indicative of at least one of the sample quality state is calculated, for example, through the use of the quality assessment module 350. At 470, a quality state of the sample is determined based on the combinatorial quality score. At 490, the mass spectrum may be designated as a reference mass spectrum of the sample if the quality score of the spectrum is sufficiently high. The reference mass spectrum may be used in future analysis of the same sample.

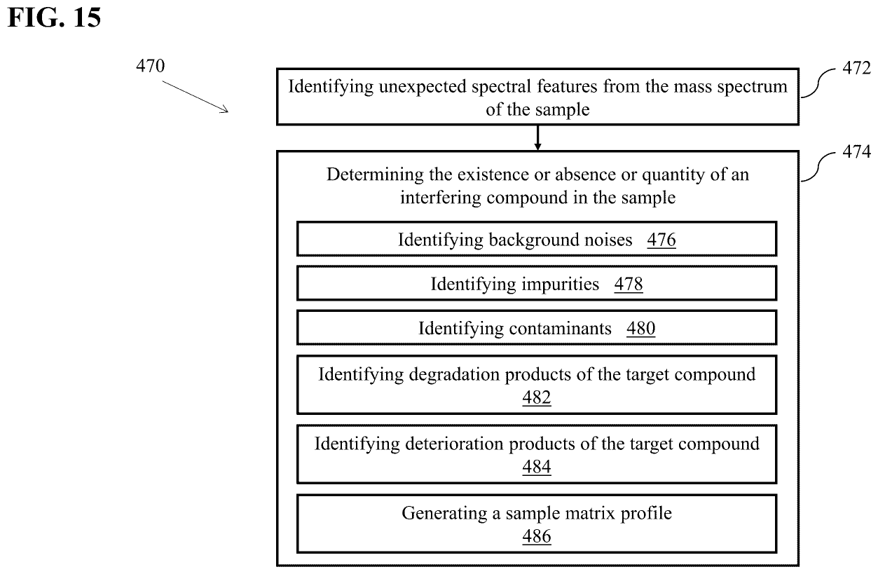

FIG. 15 illustrates a flow diagram of one particular example of operation 470 of FIG. 14. In the illustrated example, operation 470 further includes operations 472 and 474. At 472, unexpected spectral features are extracted from the mass spectrum of the sample. The unexpected spectral features, as described above, may include features indicative of interfering compound(s), features indicative of a degradation product, spectral features indicative of a deterioration product, characteristic features of the matrix of the sample, or other spectral features irrelevant to the target compound. At 474, the existence or absence or quantity of an interfering compound may be determined based on the unexpected spectral features extracted from the mass spectrum. As illustrated, operation 474 may further includes one or more or all of the following: identifying background noises of the mass spectrum at 476, identifying impurities of the sample at 478, identifying contaminants of the sample at 480, identifying degradation products of the target compound at 482, identifying deterioration produces of the target compound at 484, and generating a sample matrix profile at 486. Employment of the method 400 or any operations thereof allows users to accurately and comprehensively assess the quality of the mass spectrum and/or assess the a quality state of the sample with respect to the predefined features.

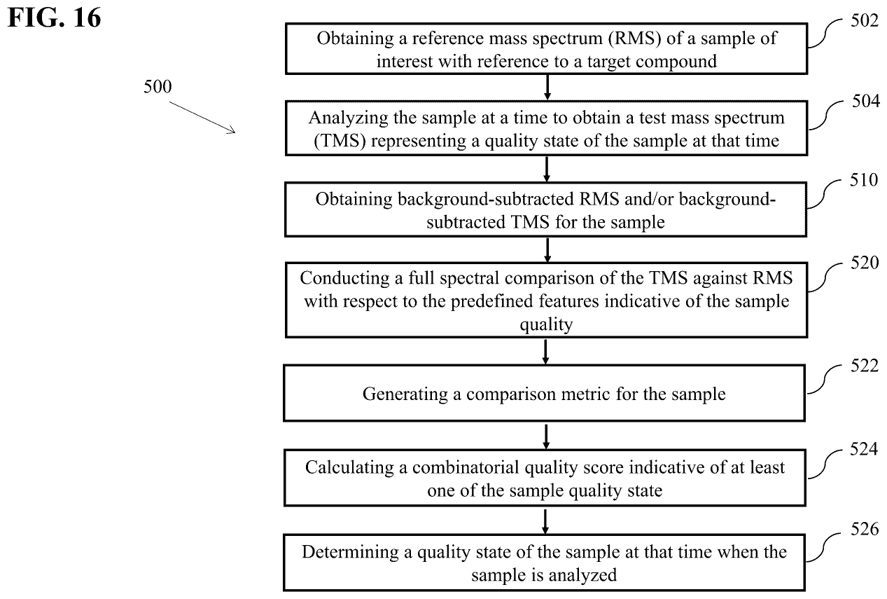

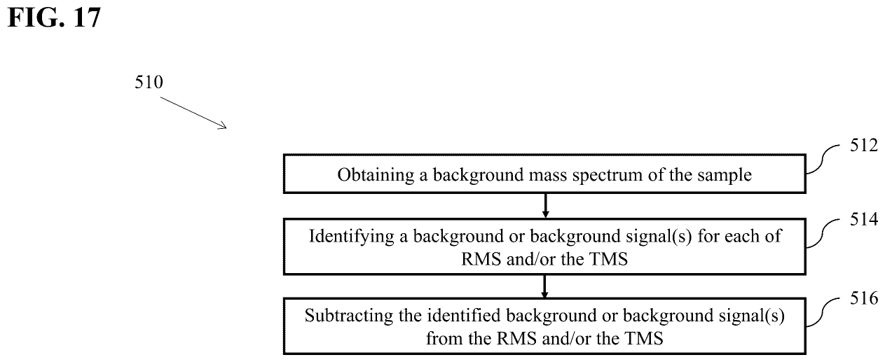

Now referring to FIGS. 16-17, examples of methods for determining quality of a sample and various aspects thereof will be illustrated and described. The methods described herein may be implemented through the use of the system 100 or any subsystems/components thereof. FIG. 16 illustrates a flow diagram of an example method 500. The method 500 includes one or more or all of operations 502, 504, 510, 520, 522, 524, and 526.

At 502, a reference mass spectrum of a sample of interest is obtained. The reference mass spectrum is used as a reference (e.g., ground truth) to determine a quality state of the sample with respect to a target compound. As discussed above, a reference mass spectrum may be obtained by analyzing a related sample known to be of standard or by designating a mass spectrum of the sample having a high quality score.

At 504, the sample is analyzed at a time to obtain a test mass spectrum representing a quality state of the sample at the time when the sample is analyzed. For example, when analyzing a chemical member of a chemical library, a reference mass spectrum may be obtained by analyzing a sample of the freshly made chemical member (with high purity). A test mass spectrum may be obtained a period of time (e.g., a month) thereafter to monitor the quality state of the same chemical member.

At 510, background-subtracted mass spectra of the test sample are obtained as described previously. At 520, a full spectral comparison of the test mass spectrum against the reference mass spectrum is conducted with respected to the predefined features indicative of the sample quantity. At 522, a comparison metric is generated for the sample. At 524, a combinatorial quality score indicative of at least one of the sample quality state is calculated based on the comparison metric. At 526, a quality state of the sample at the time when the sample is analyzed is determined, based on the comparison metric.

FIG. 17 illustrates one particular example of operation 510 of FIG. 16. Operation 510 may be performed through the use of the mass spectra analysis module 320 described above. In the illustrated example, operation 510 further includes operations 512, 514, and 516. At 512, a background mass spectrum of the sample is obtained. At 514, a background or background signal(s) for the test and/or reference mass spectra is identified. At 516, the identified background or background signal(s) are subtracted from the test and/or reference mass spectra to generate the corresponding background-subtracted mass spectra.

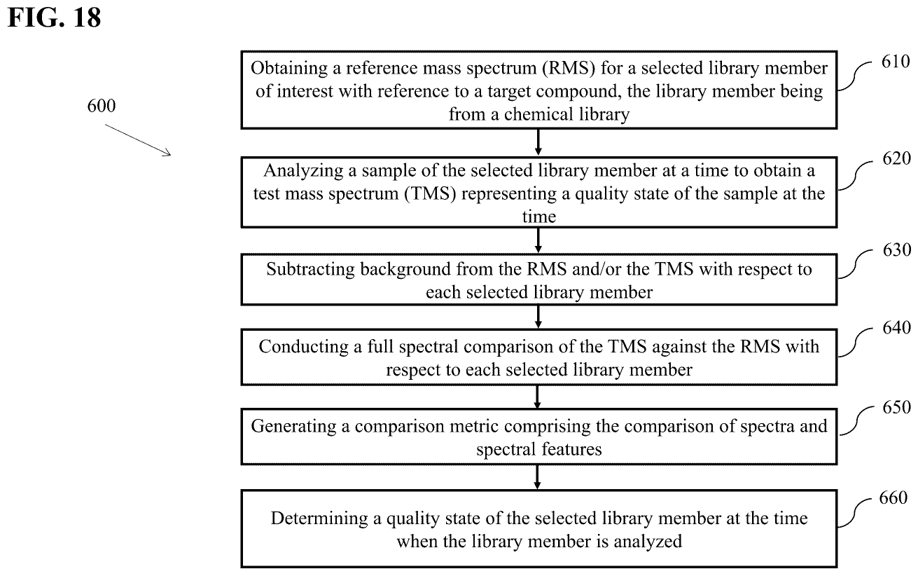

Now referring to FIG. 18, one particular example method 600 for quality control of a chemical library through the use of mass spectrometry analysis and various aspects thereof will be illustrated and described. The method 600 may be performed by the present system 100 or any subsystem/component thereof. In the illustrated example, a method 600 includes one or more or all of operations 610, 620, 630, 640, 650, and 660. At 610, a reference mass spectrum for a selected library member of interest with reference to a target compound is obtained, wherein the library member is selected from a chemical library.

At 620, a sample of the selected library member is analyzed at a time to obtain a test mass spectrum representing a quality state of the sample at the time when the sample is analyzed. At 630, a background or background signal(s) is subtracted from the test and/or reference mass spectrum with respect to each selected library member. At 640, a full spectral comparison of the test mass spectrum against the reference mass spectrum with respect to each selected library member is conducted. At 650, a comparison metric is generated, the comparison metric comprising the comparison of spectra and/or spectral features extracted therefrom. At 660, a quality state of the selected library member at the time when the library member is analyzed is determined based on the comparison metric.

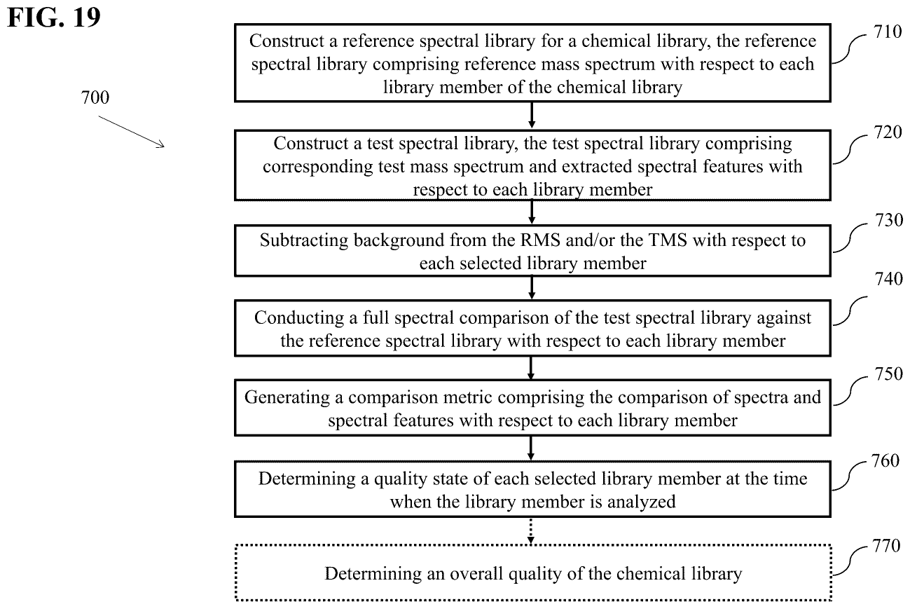

Now referring to FIG. 19, another particular example method for quality control of a chemical library and various aspects thereof will be illustrated and described. The method 700 may be performed by the present system 100 or any subsystem/component thereof. In the illustrated example, the method 700 includes one or more or all of operations 710, 720, 730, 740, 750, 760, and 770. At 710, a reference spectral library for a chemical library is constructed, for example, through the use of the spectral library construction module 360. The reference spectral library comprises reference mass spectrum with respect to each library member of the chemical library.

At 720, a test spectral library is constructed, for example, through the use of module 360. The test spectral library comprises corresponding test mass spectrum and extracted spectral features with respect to each library member. At 730, a background or background signal(s) is subtracted from the test and/or reference mass spectrum with respect to each selected library member. At 740, a full spectral comparison of the test spectral library against the reference spectral library with respect to each library member is conducted. At 750, a comparison metric comprising the comparison of spectra and spectral features with respect to each library member is generated for the chemical library. At 760, a quality state of each selected library member at the time when the library member is analyzed is determined. At 770, an overall quality of the chemical quality is determined, for example, based on weighted average of the quality scores for the library members.

Although various embodiments and examples are described herein, those of ordinary skill in the art will understand that many modifications may be made thereto within the scope of the present disclosure. Accordingly, it is not intended that the scope of the disclosure in any way be limited by the examples provided.

1. A method for assessing quality of a sample based on its mass spectrum, the method comprising:
predefining one or more features or attributes indicative of the sample quality with reference to a target compound; and
calculating a quality score for the MS with respect to the selected features or attributes.

2. The method of claim 1, wherein the predefined features are selected from the group of: expected m/z value for the target compound; intensity of the peak at expected m/z value for the target compound; fingerprint spectral feature of the target compound, spectral feature indicative of interference and/or amount of interference, spectral feature indicative of degradation or deterioration of the target compound, or combinations thereof.

3. The method of claim 1, further comprising:
extracting spectral features from the MS of the sample;
comparing the extracted features to the predefined features indicative of sample quantity;
optionally generating a comparison metric comprising the comparison between the extracted feature and the corresponding predefined feature; and
calculating a combinatorial quality score indicative of at least one of the sample quality state.

4. The method of claim 1, further comprising:
identifying unexpected spectral features from the MS of the sample; and
determining the existence or absence or quantity of an interfering compound based on the unexpected spectral features, wherein the interfering compound is selected from the group of: background noise, impurity, contaminant, a degradation product of the target compound, a deterioration product of the target compound, or any combination thereof.

5. The method of claim 1, wherein the sample is a sample of a member compound of a chemical or combinatorial library.

6. The method of claim 1, wherein the MS of the sample is used as a reference mass spectrum (RMS) with respect to the target compound, wherein the RMS has a determined spectral quality score.

7. (canceled)

8. The method of claim 7, wherein the RMS of the sample is obtained at a first time, the method further comprising:
obtaining a test mass spectrum (TMS) of the sample at a second time;
comparing the TMS with the RMS with respect to the predefined features indicative of the sample quality;
calculating a spectral quality score for the TMS with reference to the target compound; and
determining a quality state of the sample at the second time.

9. The method of claim 1, further comprising:
identifying a background or background signal(s) of the MS; and
subtracting the background or background signal(s) from the MS.

10. The method of claim 9, further comprising calculating a quality score for the background-subtracted MS.

11. The method of claim 7, further comprising:
identifying a background or background signal(s) for each of RMS and/or the TMS; and
subtracting the identified background or background signal(s) from the RMS and/or the TMS.

12. The method of claim 11, further comprising:
comparing the background-subtracted RMS with the background-subtracted TMS to calculate the spectral quality score.

13. The method of claim 7, further comprising building a reference spectral library for a chemical library, wherein the chemical library comprises at least one member compound, and wherein the reference spectral library comprises RMS of selected or all member compound(s).

14. The method of claim 1, wherein the quality score of the MS is calculated using a heuristic method.

15. The method of claim 1, wherein the quality score of the MS is calculated using a machine learning method.

16. A method of assessing quality of a sample, the method comprising:
comparing a test mass spectrum (TMS) of the sample with a corresponding reference mass spectrum (RMS) of the sample;
comparing the spectral features extracted from the TMS with predefined features or attributes derived from the RMS, wherein the predefined features or attributes are indicative of sample quality with reference to a target compound of the sample;
optionally generating a comparison metric comprising the comparisons between each extracted spectral feature and the corresponding pre-defined feature;
calculating a combinatorial quality score based on the comparison, wherein the combinatorial score is indicative of at least one quality state of the sample.

17. The method of claim 16, wherein the predefined features are selected from the group of: expected m/z value for the target compound; intensity of the peak at expected m/z value for the target compound; fingerprint spectral feature of the target compound, spectral feature indicative of interference and/or amount of interference, spectral feature indicative of degradation or deterioration of the target compound.

18. The method of claim 16, wherein the quality state of the sample is selected from the group consisting of: impurity level, contaminant, degradation of the target compound, and deterioration of the target compound.

19. The method of claim 16, further comprising:
identifying a background or background signal(s) for each of RMS and/or the TMS; and
subtracting the identified background or background signal(s) from the RMS and/or the TMS.

20. The method of claim 16, further comprising:
comparing the background-subtracted RMS with the background-subtracted TMS to calculate the spectral quality score.

21. A method of determining a quality state of a sample, the method comprising:
comparing spectral quality of a test mass spectrum (TMS) of the sample with spectral quality of a corresponding reference mass spectrum (RMS) of the sample;
wherein the TMS and RMS are compared with respect to encoded spectra and metadata.
